(19) United States
(12) Patent Application Publication
(10) Pub. No.: US 2024/0399548 A1
(43) Pub. Date: Dec. 5, 2024

(54) APPARATUS FOR EXTRACTING PACKING

(71) Applicant: Progressive Sealing Inc., Vancouver (CA)

(72) Inventors: David AXELSON, Vancouver (CA); Dan SLEMKO, Sherwood Park (CA); Michael TURACK, Yucaipa, CA (US); Nicholas BURDICK, Bellingham, WA (US)

(21) Appl. No.: 18/676,419

(22) Filed: May 28, 2024

Related U.S. Application Data
(60) Provisional application No. 63/505,034, filed on May 30, 2023.

(51) Int. Cl. B25B 27/00

(52) U.S. Cl. CPC B25B 27/0028

(57) ABSTRACT

An apparatus and method for removing packing from a gland or stuffing box of rotary equipment. The apparatus includes an anchor configured to attach the packing and a tool adaptor configured to couple the anchor to a driver tool. The anchor includes a member that extends from the tool adaptor and an anchor tip attached to a distal end of the member that is configured to attach to the packing. The tool adaptor comprises a chassis and a drive mechanism supported by the chassis. The drive mechanism engages with the member and a rotary output of the driver tool so that when the driver tool is actuated, the member is retracted relative to the chassis.

### REFERENCE TO RELATED APPLICATIONS

This application claims priority from, and the benefit under 35 USC 119 in relation to, U.S. application No. 63/505,034 filed 30 May 2023 which is hereby incorporated herein by reference.

### TECHNICAL FIELD

This invention relates to packing for sealing rotating equipment such as pumps. In particular, aspects of this invention relate to devices and methods for removing packing.

### BACKGROUND

Packing is widely used to seal rotating shafts of machines such as pumps and/or the like. Packing needs to be periodically removed and replaced to maintain a proper seal.

With use, packing becomes compressed between the rotating shaft and the gland or stuffing box in which the packing is installed. Significant pulling forces must typically be applied to remove the packing and the packing typically provides negligible purchase for manually gripping the packing. Additionally, radial clearance between the shaft and the gland or stuffing box, and axial clearance between the gland or stuffing box and the motor driving the rotating shaft can be quite small, making it physically difficult or awkward to access the packing to be removed.

Accordingly, there is a general need for improved tools and methods of extracting packing to address one or more of these challenges.

The foregoing examples of the related art and limitations related thereto are intended to be illustrative and not exclusive. Other limitations of the related art will become apparent to those of skill in the art upon a reading of the specification and a study of the drawings.

### SUMMARY

The following embodiments and aspects thereof are described and illustrated in conjunction with systems, tools and methods which are meant to be exemplary and illustrative, not limiting in scope. In various embodiments, one or more of the above-described problems have been reduced or eliminated, while other embodiments are directed to other improvements.

One aspect of the invention provides an apparatus for extracting packing. The apparatus comprises a tool adaptor including a member coupled to the tool adaptor and extending outward from the tool adaptor proximate an end thereof. An anchor is attached to the distal end of the member. The anchor is configured to attach to packing disposed in a gland or stuffing box around a rotating shaft. The tool adaptor includes a drive mechanism coupled to the member and configured to retract the member relative to the tool adaptor, thereby drawing the anchor closer to the tool adaptor. The drive mechanism is configured to connect with a rotary output of a driver tool. Actuation of the driver tool causes the drive mechanism to retract the member relative to the tool adaptor. When the anchor is attached to packing, actuation of the driver tool thereby pulls the packing from between the stuffing box and the rotating shaft. The member may be substantially rigid, or substantially inextensible but otherwise flexible.

Another aspect of the invention provides a method of extracting packing. The method comprises attaching an anchor to packing disposed between a rotating shaft and a gland or stuffing box, positioning a tool on a fixed support, such as a face of the stuffing box, the tool comprising a member extending from an end thereof, the member connecting to the anchor, and actuating the tool using a powered driver tool to retract the member, thereby pulling the anchor and the packing towards the tool until it can be removed from the stuffing box.

Another aspect of the invention provides an apparatus for extracting packing. the apparatus comprises an anchor and a tool adaptor. The anchor comprises an anchor tip including an attachment structure for attaching to the packing to be extracted, and a threaded rod coupled to the anchor tip. The tool adaptor comprises a chassis, a rotary member retained by the chassis for rotation about a first axis, the rotary member including a threaded bore configured to threadably receive the threaded rod, an axial load element for resisting axial forces developed between the chassis and the rotary member, and a mechanism for transferring rotational movement of a drive tool connectable to the tool adapter to rotational movement of the rotary member about the first axis.

The rotary member may be a first rotary member and the mechanism may include a second rotary member retained by the chassis at a position spaced apart from the first rotary member in a direction perpendicular to the first axis, the second rotary member including an engagement structure shaped to interface with a rotary output of the drive tool, and a drive train connecting the first rotary member to the second rotary member.

The drive train may include a first gear attached to the first rotary member, and a second gear attached to the second rotary member, the second gear meshing with the first gear.

The drive train may include a first gear attached to the first rotary member, a second gear attached to the second rotary member, and one or more gears arranged to mesh in a gear train extending between the first gear and the second gear. The second gear may be a worm gear.

The engagement structure may comprise a socket shaped to receive the rotary output.

The axial load element may comprise a thrust bearing disposed between the rotary member and the chassis. The thrust bearing may be arranged to be concentric with the threaded bore. The thrust bearing may be a first thrust bearing and the tool adaptor may include a second thrust bearing disposed between the chassis and the second rotary member. The second thrust bearing may be concentric with the engagement structure.

The chassis may include a base. The base may include a fulcrum ridge. The fulcrum ridge may be spaced apart from the first axis in a direction perpendicular to the first axis.

The chassis may include a coupling for removably attaching the tool adaptor to the drive tool. The coupling may comprise a removable u-bolt for extending around a head of the driver tool so as to clamp the driver tool to the chassis with a rotary output of the driver tool aligned with the engagement structure.

The attachment structure of the anchor tip may comprise a corkscrew.

The driver tool may be selected from the group consisting of a power ratchet, an electric screwdriver, a power drill, and an impact wrench.

A further aspect of the invention provides a kit for extracting packing. The kit includes the tool adaptor as described in any of paragraphs [0009]-[0017], a plurality of anchor tips, and one or more threaded rods attachable to the anchor tips. The kit may include a drive tool. The kit may include one or more flexible packing extractors attachable to the anchor tips.

Another aspect of the invention provides a method of extracting packing from a stuffing box or gland. The method comprises attaching an attachment structure of an anchor to the packing, bracing a chassis of a tool against an element that is fixed relative to the stuffing box or gland, the anchor extending from the chassis, and operating a powered drive connected to the tool to retract the anchor, drawing the attachment structure toward the chassis.

The attachment structure may comprise a corkscrew and the step of attaching the attachment structure to the packing may comprises pressing the corkscrew against the packing while rotating the attachment structure to embed the corkscrew in the packing.

The step of rotating the attachment structure may comprise rotating the anchor. The step of rotating the attachment structure may comprise attaching the attachment structure to a flexible packing extractor and rotating the flexible packing extractor.

The step of bracing the chassis against the fixed element may comprise bracing a fulcrum ridge of the chassis against the fixed element, wherein the member extends from the chassis proximate to an end of the chassis, and the method may comprise, while operating the powered drive, levering the end of the chassis away from the packing about the fulcrum edge.

Another aspect of the invention provides an apparatus for extracting packing. The apparatus comprises a chassis attachable to a driver tool, a member extending from the chassis, an anchor attached to a distal end of the member, the anchor including an attachment structure for attaching to the packing to be extracted, and a drive mechanism coupled to the chassis and connectable to a rotary output of the driver tool. The drive mechanism is configured to, when the driver tool is actuated, retract the member relative to the chassis so as to pull the anchor toward the chassis.

The member may comprise a slotted strip and the drive mechanism may include a worm gear configured to mesh with slots of the slotted strip. The slotted strip may be flexible.

The member may comprise a rack gear and the drive mechanism may include a gear meshing with the rack gear. The rack gear may be flexible.

The member may comprise a roller chain and the drive mechanism may include a sprocket engaging with the roller chain.

The member may comprise a threaded rod and the drive mechanism may include a rotatable threaded bore configured to engage with the threaded rod.

It is emphasized that the invention relates to all combinations of the above features, even if these are recited in different claims.

In addition to the exemplary aspects and embodiments described above, further aspects and embodiments will become apparent by reference to the drawings and by study of the following detailed descriptions.

### BRIEF DESCRIPTION OF THE DRAWINGS

Exemplary embodiments are illustrated in referenced figures of the drawings. It is intended that the embodiments and figures disclosed herein are to be considered illustrative rather than restrictive.

FIG. 1 is a perspective view of the packing extractor according to an example embodiment attached to an example drive tool.

FIG. 2 is a perspective view of the packing extractor of FIG. 1 removed from the drive tool.

FIG. 3 is a perspective view of a tool adaptor of the packing extractor of FIG. 1.

FIG. 4 is a bottom view of the FIG. 3 tool adaptor.

FIG. 5 is a perspective view of the FIG. 3 tool adaptor with a cover removed to show a drive mechanism of the packing extractor.

FIG. 6 is an exploded view of the FIG. 3 tool adaptor.

FIG. 7 is a section view of the FIG. 3 tool adaptor taken along line 7-7 of FIG. 4.

FIG. 8 is a perspective view of an anchor of the FIG. 1 packing extractor of according to an example embodiment.

FIG. 9 is a perspective view of the FIG. 1 packing extractor being inserted between a rotating shaft and a stuffing box.

FIG. 10 is a perspective view of the FIG. 9 packing extractor with a tool adaptor of the packing extractor supported on a face of the stuffing box.

FIG. 11 is a perspective view of the FIG. 10 packing extractor with a portion of the stuffing box removed to show an anchor of the packing extractor approaching packing inside the stuffing box.

FIG. 12 is a perspective view of the FIG. 11 packing extractor with the anchor extended into the packing.

FIG. 13 is a perspective view of the FIG. 12 packing extractor with the anchor retracted to pull the packing from the stuffing box.

FIG. 14 is a side view of a packing extractor according to a second example embodiment having a fulcrum ridge.

FIG. 15 is a bottom view of the FIG. 14 packing extractor.

FIG. 16 is a perspective view of the FIG. 14 packing extractor being used to extract packing from between a rotating shaft and a stuffing box.

### DETAILED DESCRIPTION

Throughout the following description, specific details are set forth in order to provide a more thorough understanding of the invention. However, the invention may be practiced without these particulars. In other instances, well known elements have not been shown or described in detail to avoid unnecessarily obscuring the invention. Accordingly, the specification and drawings are to be regarded in an illustrative, rather than a restrictive sense.

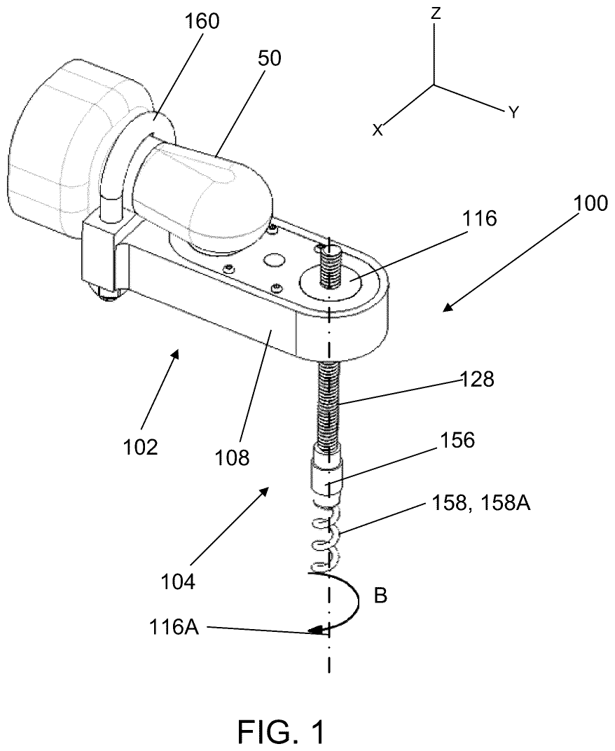

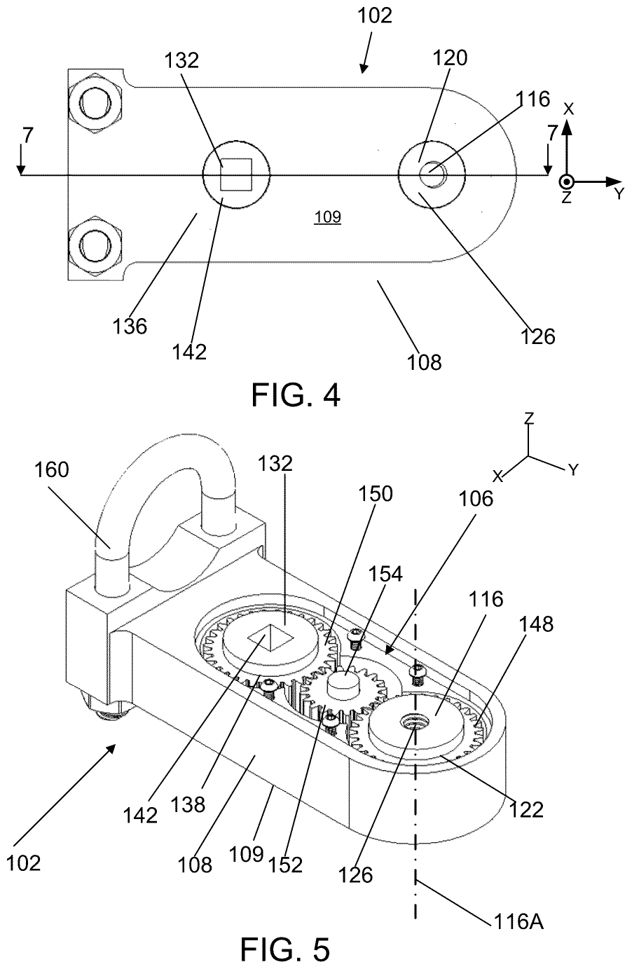

FIGS. 1-13 show a packing extractor 100 according to an example embodiment and a number of its components. Packing extractor 100 comprises a tool adaptor 102 that is attachable (optionally removably attachable) to a powered rotary drive tool 50. In some embodiments, drive tool 50 is a power ratchet. Drive tool 50 may also be, but is not limited to, a power drill, electric screwdriver, impact wrench, and/or the like.

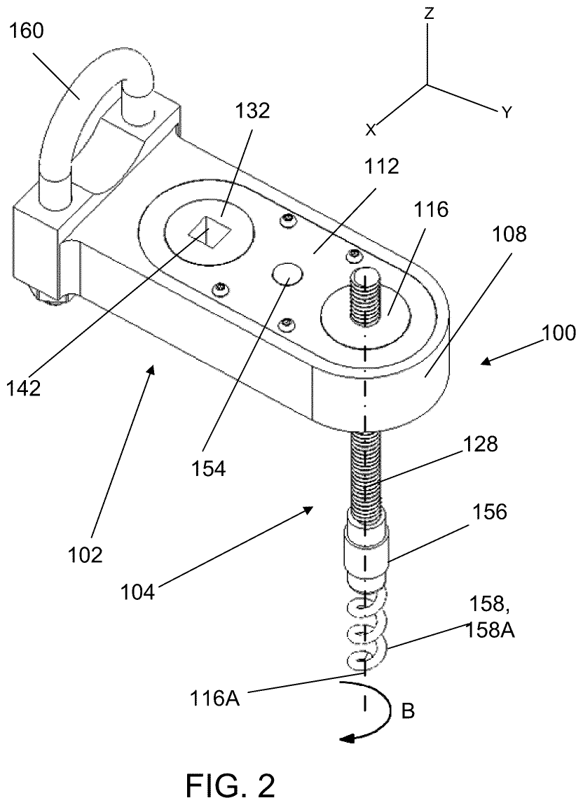

Packing extractor 100 includes an anchor 104. Anchor 104 attaches tool adaptor 102 to packing to be removed from a gland or stuffing box (not shown in FIGS. 1 and 2). Anchor 104 attaches to the packing sufficiently securely such that more pulling force is required to detach anchor 104 from the packing than is required to pull the packing from the gland. Tool adaptor 102 includes a drive mechanism 106 (shown best in FIG. 5) which converts rotary output motion from drive tool 50 into translational movement of anchor 104 along an axis 116A (i.e. in a direction parallel to the Z-axis) through and out of tool adaptor 102. Accordingly, actuating drive tool 50 when anchor 104 is attached to the packing and tool adaptor 102 is held stationary will draw anchor 104 through tool adaptor 102 or otherwise retract anchor 104 along axis 116A relative to tool adaptor 102, thereby pulling the packing out of the gland.

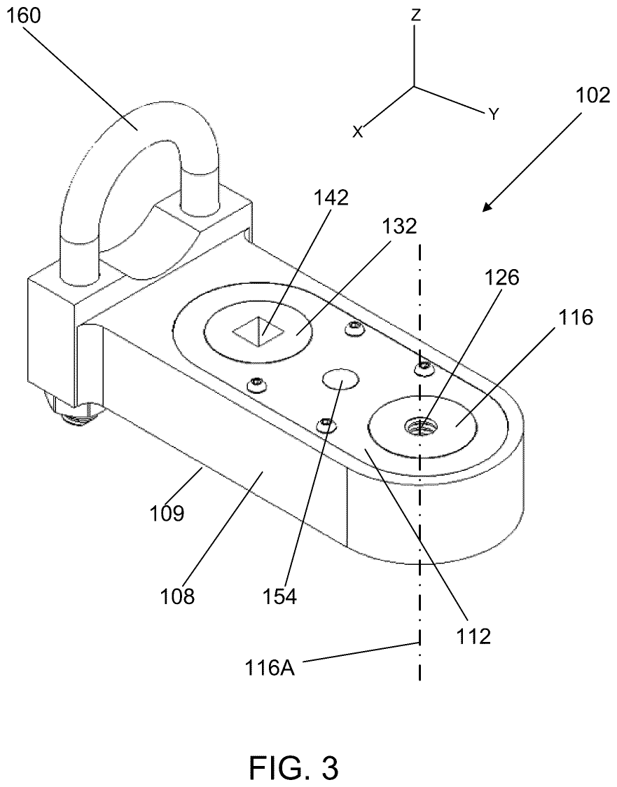

FIGS. 3-7 show tool adaptor 102 of the FIG. 1 packing extractor 100 according to an example embodiment. Tool adaptor 102 comprises a chassis 108. Chassis 108 includes a flat bottom surface 109 that can be braced against a fixed structure near the packing to be removed (e.g. braced against a portion of the stuffing box). With chassis 108 braced with flat bottom surface 109 against the fixed structure, actuation of drive mechanism 106 by drive tool 50 retracts the anchor 104 towards chassis 108 (i.e. in the Z-direction) rather than moving tool adaptor 102 in the Z-direction along anchor 104 towards the packing. Chassis 108 includes a recess 110 that houses and/or supports drive mechanism 106 and a cover 112 that attaches to chassis 108 over recess 110 to house drive mechanism 106 in recess 110. Recess 110 has a base 114. Cover 112 may be attached to chassis 108 in a permanent or removable fashion.

Drive mechanism 106 comprises a first rotary member 116 concentric with axis 116A. In some embodiments, first rotary member 116 comprises first and second axially opposed shoulders 118, 122 and is seated in chassis 108, so that first shoulder 116 abuts against base 114 and first rotary member 116 projects into and/or through bore 120 formed in base 114 and second shoulder 122 abuts against cover 112 and first rotary member 116 projects into and/or through bore 124 formed in cover 112. First rotary member 116 is thereby restrained from lateral (in directions parallel to the X-axis), longitudinal (in directions parallel to the Y-axis), and axial movement (in directions parallel to the Z-axis) by chassis 108 and cover 112, while being permitted to rotate about its Z-oriented (axially oriented) axis 116A.

First rotary member 116 includes a threaded bore 126. Threaded bore 126 is centrally positioned and concentric with axis 116A. Anchor 104 includes a threaded rod 128 that threadedly engages with threaded bore 126. If anchor 104 is free from external forces (e.g. not attached to packing) as shown in FIG. 2, rotating first rotary member 116 about axis 116A also spins anchor 104 about axis 116A, e.g. in a direction indicated by curled arrow B as shown in FIGS. 1 and 2. If anchor 104 is prevented from rotation about axis 116A by external forces, for example by attachment to the packing, then rotating first rotary member 116 about axis 116A causes threaded bore 126 to traverse along threaded rod 128 (i.e. relative translational movement between thread rod 128 and threaded bore 126) in the direction of axis 116A (e.g. relative translational movement in the Z-direction). If tool adaptor 102 is also restrained from movement (e.g. by bracing bottom surface 109 on a fixed structure such as the stuffing box), anchor 104 is drawn through threaded bore 126, i.e. along axis 116A in the Z-direction.

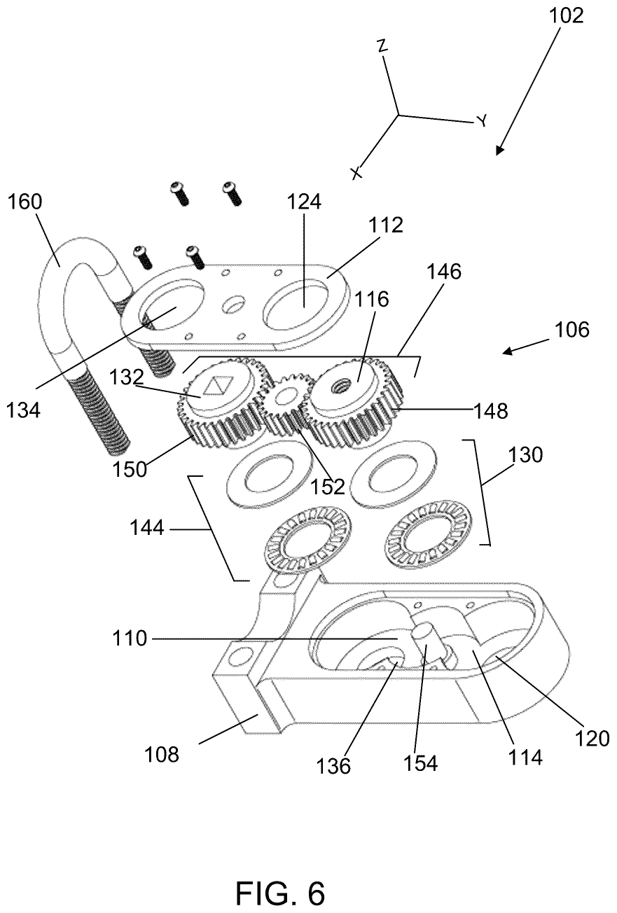

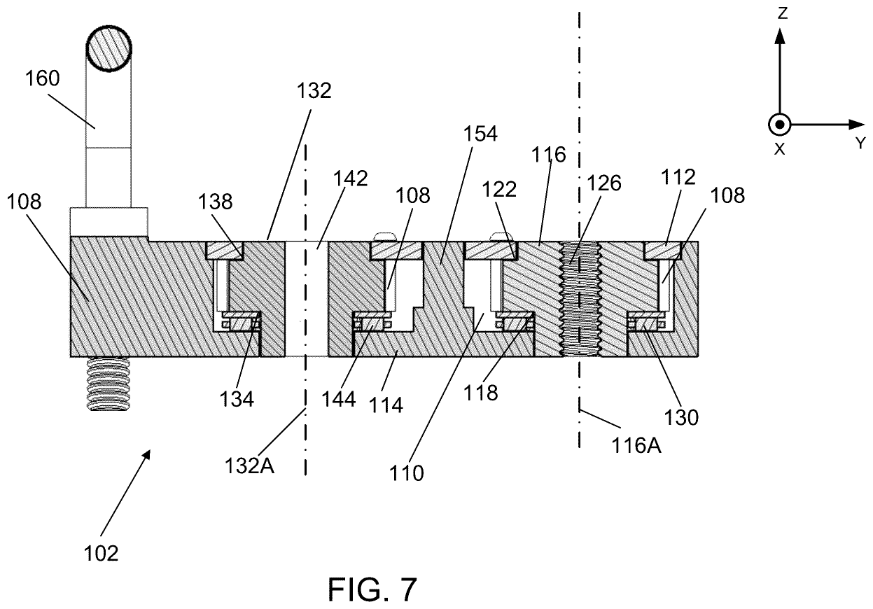

Tool adaptor 102 may include one or more axial load elements to resist the reaction forces exerted on tool adaptor 102 by the packing during extraction. In some embodiments, tool adaptor 102 includes a first thrust bearing 130 (shown best in FIGS. 6 and 7) disposed between base 114 and first shoulder 118 of first rotary member 116, i.e. first rotary member 116 projects through first thrust bearing 130 then through first through bore 120 until first shoulder 118 abuts against first thrust bearing 130.

Drive mechanism 106 comprises a second rotary member 132. In some embodiments, second rotary member 132 comprises third and fourth axially opposed shoulders 134, 138 and is seated in chassis 108, so that third shoulder 134 abuts against base 114 and second rotary member 132 projects into and/or through a second through bore 136 formed in base 114 and fourth shoulder 138 abuts against cover 112 and second rotary member 132 projects into and/or through bore 140 formed in cover 112. Second rotary member 132 is thereby restrained from lateral (in directions parallel to the X-axis), longitudinal (in directions parallel to the Y-axis), and axial movement (in directions parallel to the Z-axis) by chassis 108 and cover 112, while being permitted to rotate about its Z-oriented (axially oriented) axis 132A. second rotary member 132 may be spaced apart from first rotary member 116 in one or more of the X-direction, Y-direction, and Z-direction. For example, second rotary member 132 may be spaced apart longitudinally (i.e. in the Y-direction) from the first rotary member 116 as shown.

Second rotary member 132 of the illustrated embodiment includes an engagement structure 142 that engages with a rotary output member (not shown) of drive tool 50 so that drive tool 50 drives second rotary member 132 to rotate. In some embodiments, engagement structure 142 comprises a female socket for receiving a male ratchet head of a power ratchet as shown. In some embodiments, engagement structure 142 comprises a hexagonal cross-sectioned shaft that is received by a chuck of an electric drill or electric screwdriver.

In some embodiments, tool adaptor 102 includes a second thrust bearing 144 (shown best in FIGS. 6 and 7) disposed between base 114 and third shoulder 134 of second rotary member 132, i.e. second rotary member 132 projects through second thrust bearing 144 then through third through bore 136 until third shoulder 134 abuts second thrust bearing 144.

Drive mechanism 106 of the illustrated embodiment comprises a drive train 146 that operatively connects second rotary member 132 to first rotary member 116 so that when driver tool 50 drives second rotary member 130 to rotate about its axis 132A, first rotary member 116 is also driven to rotate about its axis 116A. In some embodiments, drive train 146 comprises a gear train comprising at least two meshing gears.

FIGS. 6 and 7 show drive mechanism 106 and drive train 146 according to a particular embodiment. Drive train 146 comprises a first spur gear 148 attached to (or integrally formed with) first rotary member 116, a second spur gear 150 attached to (or integrally formed with) second rotary member 130 and an idler gear 152 disposed on a shaft 154 extending from base 114 between first through bore 118 and second through bore 136. Idler gear 152 meshes with first spur gear 148 and second spur gear 150 so as to transmit rotation of second rotary member 128 about its axis 132A by drive tool 50 to first rotary member 116, causing first rotary member 116 to rotate about its axis 116A. First spur gear 148 may be integral with first rotary member 116 and disposed between first shoulder 118 and second shoulder 122 as shown. Similarly, second spur gear 150 may be integral with second rotary member 132 and disposed between third shoulder 134 and fourth shoulder 138 as shown.

In general, drive mechanism 106 may comprise any suitable drive train for transferring rotation from second rotary member 128 to first rotary member 116. Other non-limiting examples of drive train 146 are provided below. In some embodiments, first spur gear 148 meshes directly with second gear 150. In some embodiments, drive train 146 comprises multiple interstitial gears meshing in a gear train between first gear 148 and second gear 150. In some embodiments, drive train 138 comprises a chain drive or belt drive: first and second rotary members 116, 130 are cogged and a roller chain or drive belt couples first and second rotary members 116, 130 together. In some embodiments, first and second rotary members 116, 132 comprise a worm gear set, preferably with first rotary member 116 comprising a worm wheel and second rotary member 132 comprising a worm gear. Different aspects and embodiments of the invention contemplates these examples and more.

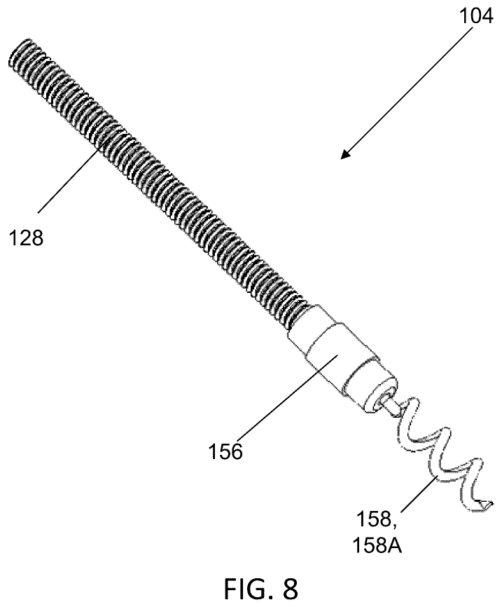

FIG. 8 shows anchor 104 according to an example embodiment. Anchor 104 comprises threaded rod 128 attached to an anchor tip 156. In some embodiments anchor tip 156 is integral with or permanently mounted to threaded rod 128. In some embodiments anchor tip 156 is releasably coupled to threaded rod 128 by any convenient known means, including but not limited to quick-connect type couplings, magnetic couplings, chucks, mechanical fasteners such as set screws, and the like.

Anchor tip 156 includes an attachment structure 158 for attaching to packing to be removed from a gland or stuffing box such that, once attachment structure 158 is attached to packing, anchor tip 156 can be pulled on with sufficient force to dislodge the packing from the gland or stuffing box without detaching anchor tip 156 (i.e. without detaching attachment structure 158, e.g. by localized deformation or destruction of the surrounding packing) from the packing.

In some embodiments, attachment structure 158 embeds in the packing. Attachment structure 158 may include features that, once attachment structure 158 is embedded in the packing (e.g. by a combination of rotational force (in direction B about axis 116A) and axial force in direction 116A) prevent dislodging of attachment structure 158 by forces tending to pull anchor tip 156 away from the packing (e.g. in axial direction 116A). That is, once attachment structure 158 is embedded in the packing (e.g. by a combination of rotational force (in direction B about axis 116A) and axial force in direction 116A), the axial force (e.g. in axial direction 116A) required to remove attachment structure 158 from the packing (e.g. by deforming or breaking the packing) is greater than the axial forces required to pull the packing from the gland or stuffing box.

In some embodiments, attachment structure 158 comprises a corkscrew 158A as shown. With corkscrew 158A contacting the packing, rotating anchor 104 while applying axial force (pushing) on anchor 104 in a direction towards the packing will tend to screw (embed) corkscrew 158A into the packing. In some embodiments, anchor 104 is manually rotated to screw corkscrew 158A into the packing. In some embodiments, drive tool 50 rotates first rotary member 116 and anchor 104 together to screw corkscrew 158A into the packing. Once embedded, applying axial force (pulling) on anchor 104 in a direction away from the packing will not dislodge corkscrew 158A and will instead tend to pull on the packing. This may be because, once corkscrew 158A is embedded, the axial force (e.g. in axial direction 116A) required to remove corkscrew 158A from the packing (e.g. by deforming or breaking the packing) is greater than the axial forces required to pull the packing from the gland or stuffing box 80.

Once corkscrew 158A is embedded in the packing, axial force (along axis 116A) may be applied to anchor 104 in a direction that tends to pull anchor 104 away from the stuffing box or gland 80 and to thereby pull the packing from the stuffing box or gland 80. In the illustrated embodiment, such axial forces may be applied to anchor 104 using tool adapter 102. In particular, rotation of first rotary member 116 about axis 116A in a particular angular direction while anchor 104 is embedded in the packing may tend to cause first rotary member 116 (and tool adaptor 102) to advance along threaded rod 128 towards anchor tip 156 (i.e. the portion of the length of threaded rod 128 disposed between chassis 108 and anchor tip 156 will decrease). If tool adaptor 102 is then prevented from further advancing towards anchor tip 156 (e.g. by bracing chassis 108 on bottom surface 109 against a fixed structure such as the stuffing box or gland 80 in which the packing is embedded), rotation of first rotary member 116 about axis 116A may generate axial force on anchor 104 in a direction away from stuffing box 80 until friction between the packing and the stuffing box 80 and rotating shaft is overcome, and anchor tip 156 and the packing will move towards tool adaptor 102 and out of stuffing box 80.

In some embodiments, attachment structure 158 comprises an auger bit or a screw bit that is embeddable into the packing by means of rotation, similar to corkscrew 158A. In some embodiments, anchor tip 156 includes a barbed point that can be driven or plunged into the packing, with or without rotation.

In some embodiments, tool adaptor 102 releasably couples to drive tool 50. In some embodiments, tool adaptor 102 includes a U-bolt 160 that clamps drive tool 50 to chassis 108 in alignment with engagement structure 142 as shown in FIG. 1. U-bolt 160 may be fully removable from chassis 108 or may be at least partially retained by chassis 108.

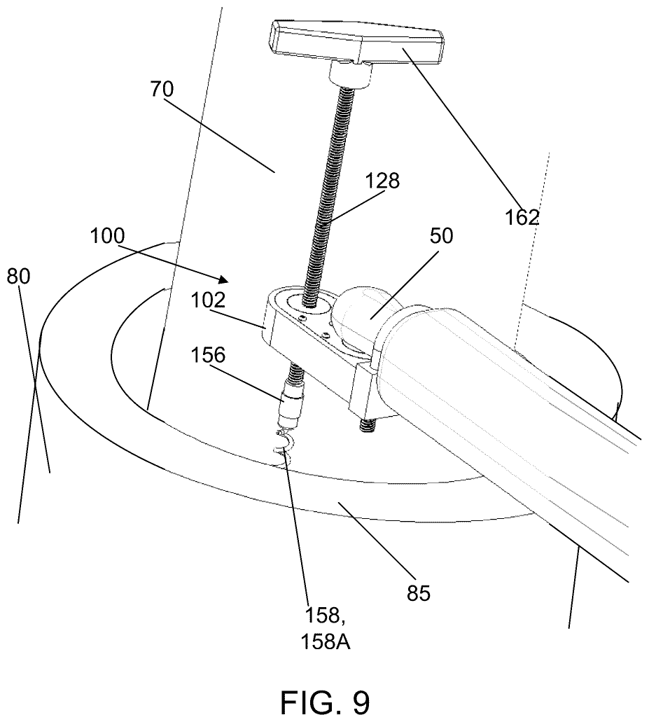

FIGS. 9 to 13 show an example method of using packing extractor 100 to extract packing 60. A removable T-handle 162 has been attached to threaded rod 128 to allow a user to manually rotate threaded rod 128 for the purpose of screwing corkscrew 158 into packing 60.

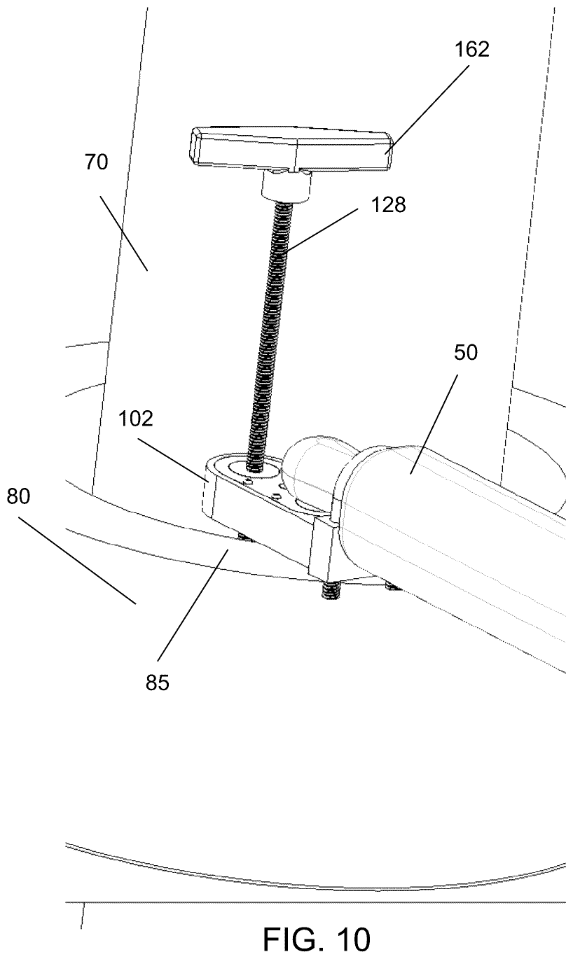

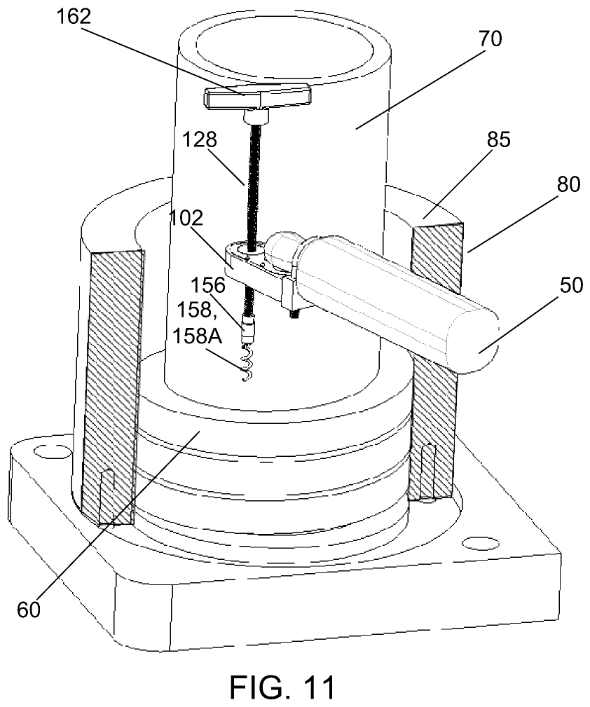

In FIG. 9, packing extractor 100 is attached to drive tool 50 and positioned so that anchor 104 can be inserted between a rotating shaft 70 and a stuffing box 80. In FIGS. 10 and 11, anchor 104 is inserted into stuffing box 80 until tool adaptor 102 is supported on a face 85 of stuffing box 80 and thereby rendered stationary.

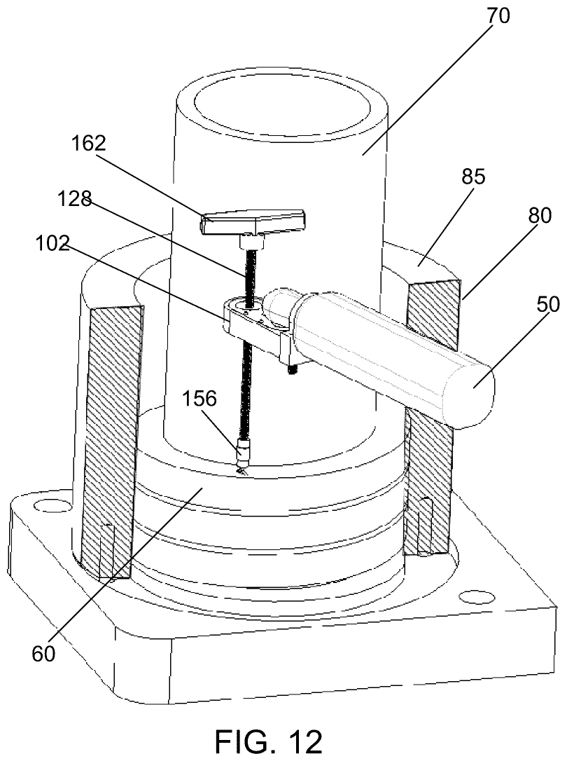

In FIG. 12, T-handle 162 has been used to rotate threaded rod 128 so as to extend anchor 104 further into stuffing box 80 and screw corkscrew 158A into packing 60. With corkscrew 158 embedded in packing 60, drive tool 50 is actuated to rotate second rotary member 132, thereby rotating first rotary member 116. In this position, tool adaptor 102 is fixed in position (by bracing against face 85) and anchor 104 cannot rotate (as a result of being embedded in packing 60). Engagement between threaded bore 126 and threaded rod 128 generates axial forces on threaded rod 128 that overcome friction between packing 60, rotating shaft 70, and stuffing box 80 and packing 60 to draw threaded rod 128 through threaded bore 126 and pull anchor tip 156 and packing 60 towards tool adaptor 102.

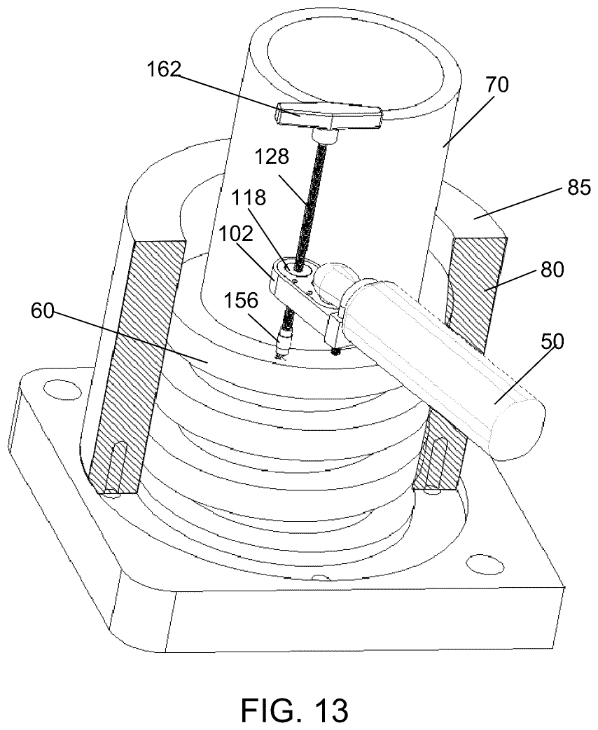

In FIG. 13, threaded rod 128 has been drawn through threaded bore 126 and packing 60 has correspondingly been pulled up through stuffing box 80. From this point, the user can continue to draw threaded rod 128 up to bring packing 60 up past face 80 of stuffing box 80. Packing extractor 100 can then be pulled on to remove packing 60 from stuffing box 80 entirely. Alternatively, the user can use their hands to manually remove packing 60. In some cases the extraction method may need to be repeated at various points around the circumference of rotating shaft 70 in order bring all of packing 60 past stuffing box 80 to reduce friction between packing 60, rotating shaft 70, and stuffing box 80 so as to reduce the amount of force necessary to remove packing 60.

In some embodiments, anchor tip 156 is first embedded in packing 60 by using a flexible packing extractor such as the GARCO™ flexible extractor made by Robinson Tools. Threaded rod 128 is then connected to anchor tip 156 and packing extractor 100 is operated as shown in FIGS. 9 to 13.

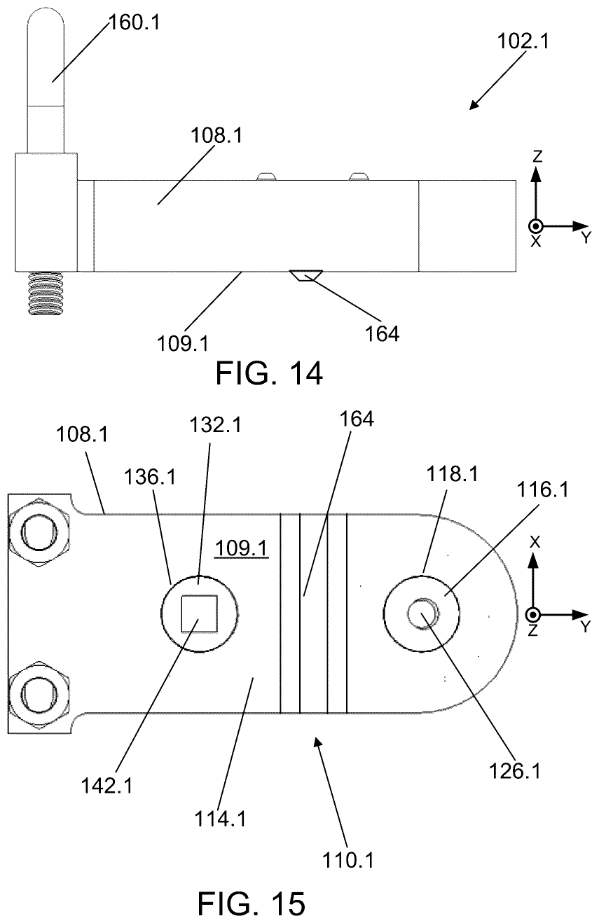

FIGS. 14 and 15 show another embodiment of a tool adaptor 102.1. Like parts have like numbers and functioning as tool adaptor 110 shown in FIGS. 1 to 9 with the addition of decimal extension “0.1.” Bottom surface 109.1 of chassis 108.1 includes a fulcrum ridge 164. In some embodiments, fulcrum ridge 164 is straight as shown. In some embodiments, fulcrum ridge 164 is trapezoidal in cross-section as shown. In other embodiments, fulcrum ridge 164 is smoothly rounded. Fulcrum ridge 164 is preferably disposed between first through bore 126.1 and second through bore 128.1.

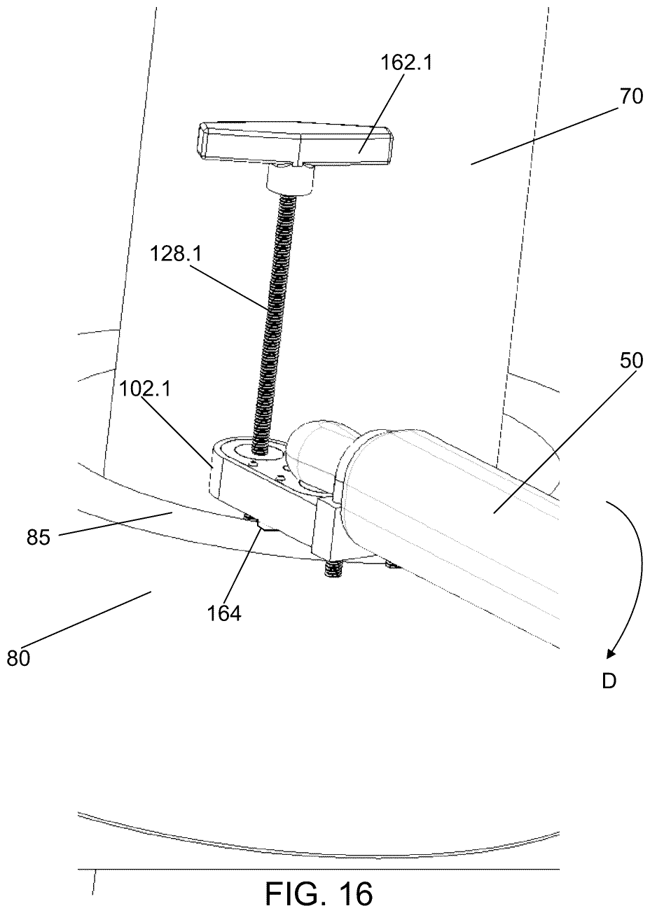

FIG. 16 shows tool adaptor 102.1 having fulcrum ridge 164 being used to extract packing 60, fulcrum ridge 158 can be rested on or braced against gland face 85. Driver tool 50 can then be pushed towards gland 70 (i.e. along a curved path indicated by arrow D) to provide additional levering action (i.e. in addition to the axial forces generated by engagement between threaded bore 126.1 and threaded rod 128.1 as first rotary member 116.1 rotates) for aiding in extraction of the packing.

According to another embodiment, a packing extractor comprises a chassis configured to be attached to a driver tool (for example with a removable u-bolt as previously described), a member extending from the chassis at near an end thereof, and a drive mechanism disposed on the chassis and operable to retract the member. The drive mechanism is couple-able to a rotary output of the driver tool so that actuation of the driver tool causes the drive mechanism to operate, thereby retracting the member relative to the chassis. In some embodiments, the member is flexible in at least one cross-sectional dimension, i.e. elastically deformable or otherwise bendable in the one cross-sectional dimension, but will not extend substantially under tension, i.e. not stretchable. An anchor is attached to a distal end of the member. The anchor is configured to attach to the packing such that, once attached, pulling on the anchor will not dislodge the anchor from the packing, e.g. by embedding in the packing.

In some embodiments, the member comprises a slotted strip. The drive mechanism comprises a worm gear that engages with slots of the slotted strip. Rotation of the worm gear causes the worm gear to advance along the slots, thereby retracting the slotted strip past the chassis. In some embodiments, the slotted strip is flexible.

In some embodiments, the member comprises a rack gear. The drive mechanism comprises a spur gear that meshes with the rack gear. The spur gear may be a worm wheel and the drive mechanism may further comprise a worm gear meshing with the worm wheel to provide additional torque. Rotation of the spur gear causes the spur gear to advance along the rack gear, thereby retracting the rack gear past the chassis. In some embodiments, the rack gear is flexible.

In some embodiments, the member comprises a roller chain. The drive mechanism comprises a cog wheel that meshes with the roller chain. Rotation of the cog wheel drives the roller chain, causing the roller chain to retract into the chassis.

In some embodiments the member comprises a cable. The drive mechanism comprises a winch system. Operation of the winch system draws the cable onto a winch barrel of the winch system, thereby pulling the anchor towards the chassis.

### Interpretation of Terms

Unless the context clearly requires otherwise, throughout the description and the claims:
“comprise”, “comprising”, and the like are to be construed in an inclusive sense, as opposed to an exclusive or exhaustive sense; that is to say, in the sense of “including, but not limited to”;
“connected”, “coupled”, or any variant thereof, means any connection or coupling, either direct or indirect, between two or more elements; the coupling or connection between the elements can be physical, logical, or a combination thereof;
“herein”, “above”, “below”, and words of similar import, when used to describe this specification, shall refer to this specification as a whole, and not to any particular portions of this specification;
“or”, in reference to a list of two or more items, covers all of the following interpretations of the word: any of the items in the list, all of the items in the list, and any combination of the items in the list;
the singular forms “a”, “an”, and “the” also include the meaning of any appropriate plural forms. These terms (“a”, “an”, and “the”) mean one or more unless stated otherwise;
“and/or” is used to indicate one or both stated cases may occur, for example A and/or B includes both (A and B) and (A or B);
“approximately” when applied to a numerical value means the numerical value±10%;
where a feature is described as being “optional” or “optionally” present or described as being present “in some embodiments” it is intended that the present disclosure encompasses embodiments where that feature is present and other embodiments where that feature is not necessarily present and other embodiments where that feature is excluded. Further, where any combination of features is described in this application this statement is intended to serve as antecedent basis for the use of exclusive terminology such as “solely,” “only” and the like in relation to the combination of features as well as the use of “negative” limitation(s)” to exclude the presence of other features; and
“first” and “second” are used for descriptive purposes and cannot be understood as indicating or implying relative importance or indicating the number of indicated technical features.

Words that indicate directions such as “vertical”, “transverse”, “horizontal”, “upward”, “downward”, “forward”, “backward”, “inward”, “outward”, “left”, “right”, “front”, “back”, “top”, “bottom”, “below”, “above”, “under”, and the like, used in this description and any accompanying claims (where present), depend on the specific orientation of the apparatus described and illustrated. The subject matter described herein may assume various alternative orientations. Accordingly, these directional terms are not strictly defined and should not be interpreted narrowly.

Where a range for a value is stated, the stated range includes all sub-ranges of the range. It is intended that the statement of a range supports the value being at an endpoint of the range as well as at any intervening value to the tenth of the unit of the lower limit of the range, as well as any subrange or sets of sub ranges of the range unless the context clearly dictates otherwise or any portion(s) of the stated range is specifically excluded. Where the stated range includes one or both endpoints of the range, ranges excluding either or both of those included endpoints are also included in the invention.

Certain numerical values described herein are preceded by “about”. In this context, “about” provides literal support for the exact numerical value that it precedes, the exact numerical value+5%, as well as all other numerical values that are near to or approximately equal to that numerical value. Unless otherwise indicated a particular numerical value is included in “about” a specifically recited numerical value where the particular numerical value provides the substantial equivalent of the specifically recited numerical value in the context in which the specifically recited numerical value is presented. For example, a statement that something has the numerical value of “about 10” is to be interpreted as: the set of statements:
in some embodiments the numerical value is 10;
in some embodiments the numerical value is in the range of 9.5 to 10.5;
   and if from the context the person of ordinary skill in the art would understand that values within a certain range are substantially equivalent to 10 because the values with the range would be understood to provide substantially the same result as the value 10 then “about 10” also includes:
in some embodiments the numerical value is in the range of C to D where C and D are respectively lower and upper endpoints of the range that encompasses all of those values that provide a substantial equivalent to the value 10

Specific examples of systems, methods and apparatus have been described herein for purposes of illustration. These are only examples. The technology provided herein can be applied to systems other than the example systems described above. Many alterations, modifications, additions, omissions, and permutations are possible within the practice of this invention. This invention includes variations on described embodiments that would be apparent to the skilled addressee, including variations obtained by: replacing features, elements and/or acts with equivalent features, elements and/or acts; mixing and matching of features, elements and/or acts from different embodiments; combining features, elements and/or acts from embodiments as described herein with features, elements and/or acts of other technology; and/or omitting combining features, elements and/or acts from described embodiments.

As will be apparent to those of skill in the art upon reading this disclosure, each of the individual embodiments described and illustrated herein has discrete components and features which may be readily separated from or combined with the features of any other described embodiment(s) without departing from the scope of the present invention.

Any aspects described above in reference to apparatus may also apply to methods and vice versa.

Any recited method can be carried out in the order of events recited or in any other order which is logically possible. For example, while processes or blocks are presented in a given order, alternative examples may perform routines having steps, or employ systems having blocks, in a different order, and some processes or blocks may be deleted, moved, added, subdivided, combined, and/or modified to provide alternative or subcombinations. Each of these processes or blocks may be implemented in a variety of different ways. Also, while processes or blocks are at times shown as being performed in series, these processes or blocks may instead be performed in parallel, simultaneously or at different times.

Various features are described herein as being present in “some embodiments”. Such features are not mandatory and may not be present in all embodiments. Embodiments of the invention may include zero, any one or any combination of two or more of such features. All possible combinations of such features are contemplated by this disclosure even where such features are shown in different drawings and/or described in different sections or paragraphs. This is limited only to the extent that certain ones of such features are incompatible with other ones of such features in the sense that it would be impossible for a person of ordinary skill in the art to construct a practical embodiment that combines such incompatible features. Consequently, the description that “some embodiments” possess feature A and “some embodiments” possess feature B should be interpreted as an express indication that the inventors also contemplate embodiments which combine features A and B (unless the description states otherwise or features A and B are fundamentally incompatible). This is the case even if features A and B are illustrated in different drawings and/or mentioned in different paragraphs, sections or sentences.

The invention has a number of non-limiting aspects. Non-limiting aspects of the invention include:
1. Apparatus for extracting packing, the apparatus comprising:
   an anchor, the anchor comprising:
      an anchor tip including an attachment structure for attaching to the packing to be extracted; and
      a threaded rod coupled to the anchor tip; and
   a tool adaptor, the tool adaptor comprising:
      a chassis;
      a rotary member retained by the chassis for rotation about a first axis, the rotary member including a threaded bore configured to threadably receive the threaded rod;
      an axial load element for resisting axial forces developed between the chassis and the rotary member; and
      a mechanism for transferring rotational movement of a drive tool connectable to the tool adapter to rotational movement of the rotary member about the first axis.
2. Apparatus according to aspect 1 or any other aspect herein, wherein the rotary member is a first rotary member and wherein the mechanism includes:
   a second rotary member retained by the chassis at a position spaced apart from the first rotary member in a direction perpendicular to the first axis, the second rotary member including an engagement structure shaped to interface with a rotary output of the drive tool; and
   a drive train connecting the first rotary member to the second rotary member.
3. Apparatus according to aspect 2 or any other aspect herein, wherein the drive train includes:
   a first gear attached to the first rotary member; and
   a second gear attached to the second rotary member, the second gear meshing with the first gear.
4. Apparatus according to aspect 2 or any other aspect herein, wherein the drive train includes:
   a first gear attached to the first rotary member;
   a second gear attached to the second rotary member; and
   one or more gears arranged to mesh in a gear train extending between the first gear and the second gear.
5. Apparatus according to aspect 3 or 4 or any other aspect herein, wherein the second gear is a worm gear.
6. Apparatus according to any one of aspects 2 to 5 or any other aspect herein, wherein the engagement structure comprises a socket shaped to receive the rotary output.
7. Apparatus according to any one of aspects 2 to 6 or any other aspect herein, wherein the axial load element comprises a thrust bearing disposed between the first rotary member and the chassis, the thrust bearing arranged to be concentric with the threaded bore.
8. Apparatus according to aspect 7 or any other aspect herein, wherein the thrust bearing is a first thrust bearing and wherein the tool adaptor includes a second thrust bearing disposed between the chassis and the second rotary member, the second thrust bearing arranged to be concentric with the engagement structure.
9. Apparatus according to any one of aspects 1 to 7, or any other aspect herein, wherein the chassis includes a base, the base including a fulcrum ridge.
10. Apparatus according to aspect 9 or any other aspect herein, wherein the fulcrum ridge is spaced apart from the first axis in a direction perpendicular to the first axis.
11. Apparatus according to any one of aspects 1 to 10 or any other aspect herein, wherein the chassis includes a coupling for removably attaching the tool adaptor to the drive tool.
12. Apparatus according to aspect 11 or any other aspect herein, wherein the coupling comprises a removable u-bolt for extending around a head of the drive tool so as to clamp the drive tool to the chassis with a rotary output of the drive tool aligned with the engagement structure.
13. Apparatus according to any of aspects 1 to 12 or any other aspect herein, wherein the attachment structure of the anchor tip comprises a corkscrew.
14. Apparatus according to any of aspects 1 to 13 or any other aspect herein, wherein the drive tool is selected from the group consisting of a power ratchet, an electric screwdriver, a power drill, and an impact wrench.
15. A kit for extracting packing, the kit including:
   a tool adaptor according to any of aspects 1 to 13 or any other aspect herein;
   a plurality of anchor tips; and
   one or more threaded rods attachable to said anchor tips.
16. A kit according to aspect 15 or any other aspect herein, wherein the kit includes a drive tool according to aspect 14 or any other aspect herein.
17. A kit according to aspect 15 or aspect 16 or any other aspect herein, wherein the kit includes one or more flexible packing extractors attachable to said anchor tips.
18. A method of extracting packing from a stuffing box or gland, the method comprising:
   attaching an attachment structure of an anchor to the packing;
   bracing a chassis of a tool against an element that is fixed relative to the stuffing box or gland, the anchor extending from the chassis; and
   operating a powered drive connected to the tool to retract the anchor, drawing the attachment structure toward the chassis.
19. The method according to aspect 18 or any other aspect herein, wherein the attachment structure comprises a corkscrew and wherein the step of attaching the attachment structure to the packing comprises pressing the corkscrew against the packing while rotating the attachment structure to embed the corkscrew in the packing.
20. The method according to aspect 18 or any other aspect herein, wherein the step of rotating the attachment structure comprises rotating the anchor.
21. The method according to aspect 18 or any other aspect herein, wherein the step of rotating the attachment structure comprises attaching the attachment structure to a flexible packing extractor and rotating the flexible packing extractor.
22. The method according to any one of aspects 18 to 21 or any other aspect herein, wherein the step of bracing the chassis against the fixed element comprises bracing a fulcrum ridge of the chassis against the fixed element, wherein the member extends from the chassis proximate to an end of the chassis, and wherein the method comprises, while operating the powered drive, levering the end of the chassis away from the packing about the fulcrum edge.
23. Apparatus for extracting packing, the apparatus comprising:
   a chassis attachable to a driver tool;
   a member extending from the chassis;
   an anchor attached to a distal end of the member, the anchor including an attachment structure for attaching to the packing to be extracted; and
   a drive mechanism coupled to the chassis and connectable to a rotary output of the driver tool, the drive mechanism configured to, when the driver tool is actuated, retract the member relative to the chassis so as to pull the anchor toward the chassis.
24. Apparatus according to aspect 23 or any other aspect herein, wherein the member comprises a slotted strip and the drive mechanism includes a worm gear configured to mesh with slots of the slotted strip.
25. Apparatus according to aspect 24 or any other aspect herein, wherein the slotted strip is flexible.
26. Apparatus according to aspect 23 or any other aspect herein, wherein the member comprises a rack gear and wherein the drive mechanism includes a gear meshing with the rack gear.
27. Apparatus according to aspect 26 or any other aspect herein, wherein the rack gear is flexible.
28. Apparatus according to aspect 23 or any other aspect herein, wherein the member comprises a roller chain and wherein the drive mechanism includes a sprocket engaging with the roller chain.
29. Apparatus according to aspect 23 or any other aspect herein, wherein the member comprises a threaded rod and the drive mechanism includes a rotatable threaded bore configured to engage with the threaded rod.
30. Apparatus having any new and inventive feature, combination of features, or sub-combination of features as described herein.
31. Methods having any new and inventive steps, acts, combination of steps and/or acts or sub-combination of steps and/or acts as described herein.

While a number of exemplary aspects and embodiments have been discussed above, those of skill in the art will recognize certain modifications, permutations, additions and sub-combinations thereof. It is therefore intended that the following appended claims and claims hereafter introduced are interpreted to include all such modifications, permutations, additions and sub-combinations as are consistent with the broadest interpretation of the specification as a whole.

What is claimed is:

1. Apparatus for extracting packing, the apparatus comprising:
an anchor, the anchor comprising:
an anchor tip including an attachment structure for attaching to the packing to be extracted; and
a threaded rod coupled to the anchor tip; and
a tool adaptor, the tool adaptor comprising:
a chassis;
a rotary member retained by the chassis for rotation about a first axis, the rotary member including a threaded bore configured to threadably receive the threaded rod;
an axial load element for resisting axial forces developed between the chassis and the rotary member; and
a mechanism for transferring rotational movement of a drive tool connectable to the tool adapter to rotational movement of the rotary member about the first axis.

2. Apparatus according to claim 1, wherein the rotary member is a first rotary member and wherein the mechanism includes:
a second rotary member retained by the chassis at a position spaced apart from the first rotary member in a direction perpendicular to the first axis, the second rotary member including an engagement structure shaped to interface with a rotary output of the drive tool; and
a drive train connecting the first rotary member to the second rotary member.

3. Apparatus according to claim 2, wherein the drive train includes:
a first gear attached to the first rotary member; and
a second gear attached to the second rotary member, the second gear meshing with the first gear.

4. Apparatus according to claim 2, wherein the drive train includes:
a first gear attached to the first rotary member;
a second gear attached to the second rotary member; and
one or more gears arranged to mesh in a gear train extending between the first gear and the second gear.

5. Apparatus according to claim 3, wherein the second gear is a worm gear.

6. Apparatus according to claim 2, wherein the engagement structure comprises a socket shaped to receive the rotary output.

7. Apparatus according to claim 2, wherein the axial load element comprises a thrust bearing disposed between the first rotary member and the chassis, the thrust bearing arranged to be concentric with the threaded bore.

8. Apparatus according to claim 7, wherein the thrust bearing is a first thrust bearing and wherein the tool adaptor includes a second thrust bearing disposed between the chassis and the second rotary member, the second thrust bearing arranged to be concentric with the engagement structure.

9. Apparatus according to claim 1, wherein the chassis includes a base, the base including a fulcrum ridge.

10. Apparatus according to claim 9, wherein the fulcrum ridge is spaced apart from the first axis in a direction perpendicular to the first axis.

11. Apparatus according to claim 1, wherein the chassis includes a coupling for removably attaching the tool adaptor to the drive tool.

12. Apparatus according to claim 11, wherein the coupling comprises a removable u-bolt for extending around a head of the drive tool so as to clamp the drive tool to the chassis with a rotary output of the drive tool aligned with the engagement structure.

13. Apparatus according to claim 1, wherein the attachment structure of the anchor tip comprises a corkscrew.

14. Apparatus according to claim 1, wherein the drive tool is selected from the group consisting of a power ratchet, an electric screwdriver, a power drill, and an impact wrench.

15. A kit for extracting packing, the kit including:
a tool adaptor according to claim 1;
a plurality of anchor tips; and
one or more threaded rods attachable to said anchor tips.

16. A kit according to claim 15, wherein the kit includes a drive tool selected from the group consisting of a power ratchet, an electric screwdriver, a power drill, and an impact wrench.

17. A kit according to claim 15, wherein the kit includes one or more flexible packing extractors attachable to said anchor tips.

18. A method of extracting packing from a stuffing box or gland, the method comprising:
attaching an attachment structure of an anchor to the packing;
bracing a chassis of a tool against an element that is fixed relative to the stuffing box or gland, the anchor extending from the chassis; and
operating a powered drive connected to the tool to retract the anchor, drawing the attachment structure toward the chassis.

19. The method according to claim 18, wherein the attachment structure comprises a corkscrew and wherein the step of attaching the attachment structure to the packing comprises pressing the corkscrew against the packing while rotating the attachment structure to embed the corkscrew in the packing.

20. The method according to claim 18, wherein the step of rotating the attachment structure comprises rotating the anchor.

21. The method according to claim 18, wherein the step of rotating the attachment structure comprises attaching the attachment structure to a flexible packing extractor and rotating the flexible packing extractor.

22. The method according to claim 18, wherein the step of bracing the chassis against the fixed element comprises bracing a fulcrum ridge of the chassis against the fixed element, wherein the member extends from the chassis proximate to an end of the chassis, and wherein the method comprises, while operating the powered drive, levering the end of the chassis away from the packing about the fulcrum edge.

23. Apparatus for extracting packing, the apparatus comprising:
a chassis attachable to a driver tool;
a member extending from the chassis;
an anchor attached to a distal end of the member, the anchor including an attachment structure for attaching to the packing to be extracted; and
a drive mechanism coupled to the chassis and connectable to a rotary output of the driver tool, the drive mechanism configured to, when the driver tool is actuated, retract the member relative to the chassis so as to pull the anchor toward the chassis.

24. Apparatus according to claim 23, wherein the member comprises a slotted strip and the drive mechanism includes a worm gear configured to mesh with slots of the slotted strip.

25. Apparatus according to claim 24, wherein the slotted strip is flexible.

26. Apparatus according to claim 23, wherein the member comprises a rack gear and wherein the drive mechanism includes a gear meshing with the rack gear.

27. Apparatus according to claim 26, wherein the rack gear is flexible.

28. Apparatus according to claim 23, wherein the member comprises a roller chain and wherein the drive mechanism includes a sprocket engaging with the roller chain.

29. Apparatus according to claim 23, wherein the member comprises a threaded rod and the drive mechanism includes a rotatable threaded bore configured to engage with the threaded rod.
